(19) United States
(12) Patent Application Publication
(10) Pub. No.: US 2021/0102386 A1
(43) Pub. Date: Apr. 8, 2021

(54) BALANCING FLOORING TILE UPCURL BY REVERSE SHRINKAGE

(71) Applicant: ENGINEERED FLOORS LLC, Dalton, GA (US)

(72) Inventors: Stephen TSIARKEZOS, Elkton, MD (US); John Joseph Matthews REES, Chattanooga, TN (US); Dimitri ZAFIROGLU, Centreville, DE (US)

(21) Appl. No.: 17/064,840

(22) Filed: Oct. 7, 2020

Related U.S. Application Data
(60) Provisional application No. 62/912,293, filed on Oct. 8, 2019.

(51) Int. Cl. E04F 15/10; B32B 7/12; B32B 5/02; B32B 7/028; B32B 27/12

(52) U.S. Cl. CPC E04F 15/107; B32B 7/12; B32B 5/022; B32B 2307/30; B32B 27/12; B32B 2471/00; B32B 7/028

(57) ABSTRACT

A shrinkable material is attached to the backside of a floorcovering tile and allowed to shrink to a controlled extent to produce a backside shrinking that counteracts the tendency of the tile to warp out of plane on the floor as temperature and humidity vary during installation or while in use. The tile assumes a slightly convex shape in one or two directions that can be overcome as it is adhesively attached to the floor. The added material may also serve a secondary function as pressure sensitive adhesive, a friction layer, a fluid barrier, or a cushioning surface.

### CROSS-REFERENCE TO RELATED APPLICATIONS

This application claims priority to U.S. Provisional Patent Application No. 62/912,293, filed Oct. 8, 2019, the entire contents of which are incorporated herein by reference.

### TECHNICAL FIELD

Embodiments of the subject matter disclosed herein relate to modular flat surface coverings such as flooring tiles.

### BACKGROUND

A basic requirement of modular flooring, commonly referred to as flooring tiles, is to lay flat on the floor and to remain flat when subjected to variations in temperature and humidity and to stresses during use. Flooring tiles composed of two or more layers thermally laminated together provide a challenge to this basic requirement. The individual layers cool at different rates after lamination, and these differing rates of cooling cause the floor tile to warp out of plane.

Another challenge is created by the relative expansion or contraction of a face layer compared to the lower layers. Expansion of the face layer of the flooring tile is more easily accommodated by more compliant lower layers, e.g., cushion layers. While it is difficult for the adhesively attached center of a flooring tile to rise, the edges are more easily moved. When the face layer or other upper layers are denser and shrink more than the lower layers, the edges of the flooring tile tend to curl upwards, i.e., create “up-curl”, peeling the edges off the floor. This up-curl also creates gaps between adjacent installed flooring tiles and is particularly pronounced in composite flooring tiles having relatively dense fibrous or non-fibrous polymeric face layers attached to relatively softer and compliant backings such as foamed or felted backings. The denser exposed face layers tend to overpower the porous and softer lower layers or backings and warp the edges of the flooring tile off the floor.

Referring to FIG. 1, a conventional composite flooring tile 100 has a top layer 101 with a top side or top surface 103. The top layer is attached to a compliant backing 102 having a backside or back surface 104. The flooring tile 100 is installed on a surface 110, e.g., a floor, with the backside 104 facing the floor and a layer of adhesive between the backside and the floor to hold the flooring tile down on the floor. Following the installation of the flooring tile 100, changes in temperature and humidity produce a shrinking force in the top layer 101. This shrinking force pulls the edges 105 of the top layer inward, which also pulls the edges of the flooring tile upward, away from the surface 110 in the direction of arrow A. Movement of the edges upward creates gaps 106 between the backside 104 and the surface.

Traditionally, stiff and thermally and hygroscopically stable layers such as glass are introduced under or near the exposed surface of the flooring tile to solve the problem of flooring tile up-curl with face layer shrinkage. However, the presence of these stabilizing materials makes recycling of the tile difficult. Alternative methods used to address the up-curl problem include cooling or relaxing the tiles under restraint or equipping the tiles with relatively heavy backings to promote retention of flatness during installation or use on the floor. These conventional solutions increase cost, reduce softness and flexibility in the flooring tile and make recycling more complex.

Therefore, the need still exists for a simpler, less expensive and more environmentally friendly method of reducing the tendency of flooring tiles with denser surface layers and softer backings to up-curl.

### SUMMARY

Exemplary embodiments are directed to a method for counterbalancing the tendency of a flooring tile to shrink along the exposed top surface and warp out-of-plane at one or more edges. These exemplary methods are also used for other types of tiles including wall covering tiles. Exemplary embodiments are also directed to the floor covering tiles. A material is attached to the backside of a flooring tile that produces a backside force, e.g., a backside shrinking force, that counterbalances the topside shrinking force and prevents up-curl in the flooring tile. For example, a hot polymeric layer is attached to the backside of a tile and when allowed to cool and to shrink under limited or controlled restraint develops sufficiently high shrinkage forces within the cooled polymeric layer to function as a counter-layer to counteract the shrinkage of the upper exposed topside or face layers. In other embodiments, an elastic material is attached to the backside of the flooring tile. The elastic material is attached under tension in one, two or more directions across the backside in either one or two steps.

In one embodiment, the resulting backside shrinking force produces a slightly convex, vaulted, or domed shape in the flooring tile when viewed from the topside or top surface. This convex, vaulted or domed shape holds the edges down, and the middle of the flooring tile is elevated, countering any tendency of the flooring tile to form a concave structure with up-curl at the edges. During installation of the flooring tile, adhesive attachment is used to overcome the slightly convex, vaulted or domed shape. The edges contact the floor first, and the adhesive holds the middle of the flooring tile on the floor. In one embodiment, the weight of the flooring tile is sufficient to overcome the slightly convex, vaulted, or domed shape and to hold the flooring tile down on the floor.

In one embodiment, the material is attached to the backside as a planarly-contiguous and uniform bottom layer to provide a backside shrinkage force in all directions across the backside. In one embodiment, the material is attached to the backside of the flooring tile as a planarly variable layer or as a layer selectively arranged to generate backside shrinking forces in a particular direction or in a particular pattern. In one embodiment, the particular direction or the particular pattern is used to counteract a given pattern in the topside shrinking force. In one embodiment, the material also functions as a pressure-sensitive adhesive (PSA) layer, an adhesive-carrying sublayer, a liquid-blocking sublayer, a cushioning sublayer, a slip-resisting sublayer, a soundproofing sublayer, an antimicrobial sublayer, or a reinforcing sublayer.

In one embodiment, separate material is not added to the backside of the flooring tile, and the material is created by forming a thermoplastic layer on the backside by applying heat and pressure to the backside or bottom surface of the flooring tile, e.g., a thermoplastic flooring tile, to form a thin and contiguous fused layer. This fused layer is cooled. Cooling solidifies and shrinks the thermoplastic layer, producing the desired backside shrinking force.

In one embodiment, the flooring tile has a compliant fibrous felt backing. In one embodiment, the tile has a fibrous structure, and the backside has a fibrous surface. In one embodiment, the tile has a face, and the face is a solid polymeric material. The shrinkable material is attached to the backside of the tile. In one embodiment, the material is a pressure sensitive adhesive (PSA). In one embodiment, the material is attached as a contiguous solid layer film or as a contiguous porous layer film. In one embodiment, the material is attached as a plurality of parallel lines or parallel strips of material. Adjacent lines or strips of material are spaced from one another across the backside. In one embodiment, the backside is a porous surface, and the material is attached as a polymeric sublayer that engages pores in the porous surface.

In one embodiment, the material is attached by depositing a layer of heated polymer to the backside of the tile and allowing the deposited layer of heated polymer to cool in situ. In one embodiment, the heated polymeric layer is arranged as one or more patterns of strips or yarns that are deposited at a temperature substantially above a normal room temperature. In one embodiment, the heated polymeric layer is deposited at a temperature above 150° F. The strips or yarns of heated polymer shrink in situ as they cool. In one embodiment, the strips or yarns of heated polymer include a parallel and rectilinear pattern of strips or yarns. In one embodiment, the strips or yarns form an undulating pattern of strips or yarns. In one embodiment, the strips or yarns are a combination of a parallel and rectilinear pattern of strips or yarns and an undulating pattern of strips or yarns. In one embodiment, the strips or yarns form a diagonal and crossing pattern of strips or yarns.

The attached material shrinks and produces a sufficient shrinking force in at least one direction across the backside to counteract that topside shrinking force that develops with variations in ambient conditions such as temperature and humidity during further processing, installation, and use. In one embodiment, the flooring tile under the backside shrinking force assumes a slightly convex shape before installation on a floor, and the flooring tile flattens against the floor under a force resulting from a weight of the flooring tile or from adhesive applied between the flooring tile and the floor.

In one embodiment, attaching the material includes applying a PSA in a molten state to at least a portion of the backside, allowing the molten PSA to penetrate a porous backside of the flooring tile at least partially, and cooling and shrinking the backside of the flooring tile. In one embodiment, attaching the material includes attaching an elastic layer under tension to the backside of the flooring tile, and allowing the material to shrink includes allowing the elastic layer to shrink after attachment when tension is released. In one embodiment, attaching the material includes attaching a pattern of elastic strips or yarns under tension to the backside of the tile under tension, and allowing the material to shrink includes allowing the pattern of elastic strips or yarns to shrink after attachment when tension is released.

In one embodiment a dual-layer low-melt/high-melt film is attached to the backside of the tile at a temperature causing the low-melt layer to melt and the high melt layer to stay hot and cool under limited or no restraint to cause the bottom to shrink. In one embodiment, breathable liquid blocking layers are attached with heat to the backside and allowed to shrink to cause slight doming. In one embodiment, continuous or discontinuous layers are deposited or applied to the backside as molten layers. These molten layers solidify and shrink as they cool, forcing the backside of the tile to shrink to a desired extent in one or more directions across the tile.

In one embodiment, attaching the material includes attaching the material in accordance with a pattern that is differentially or exclusively concentrated along edges of the flooring tile. In one embodiment, attaching the material includes attaching the material in accordance with a plaid pattern of lines or strips. In one embodiment, the material is a thermoplastic film, and attaching the material includes attaching the thermoplastic film at a high temperature to the backside and allowing the thermoplastic film to shrink. In one embodiment, the material is a breathable membrane, and attaching the material includes attaching the breathable membrane to the backside at an elevated temperature using a separate intermediate adhesive layer. In one embodiment, the material is a polymeric material, and attaching the material includes attaching the polymeric material to the backside as a polymeric layer, needle punching the polymeric layer to the backside, raising a temperature of the flooring tile adjacent the backside under restraint and cooling the flooring tile under reduced restraint or no restraint to allow the attached polymeric layer to shrink. In one embodiment, the material is a woven or non-woven polymeric fabric or cross-bonded scrim, and attaching the material includes preheating the shrinkable counter-layer before attachment and allowing woven or non-woven polymeric fabric or cross-bonded scrim to cool after attachment. In one embodiment, the material attached to the backside is a dual coextruded high-melt/low-melt film. In one embodiment, the dual coextruded high-melt/low-melt film is applied at an elevated temperature that is sufficient to melt the low melting layer placed against the bottom of the tile and to attach the outer layer to the bottom of the flooring tile. This application is followed by cooling of the composite, which causes the higher-melting layer to shrink in-place and create a slightly convex flooring tile. In one embodiment the low melt layer melts below 150° C., and the high melting layer melts above 180° C.

Exemplary embodiments are also directed to a method for counterbalancing shrinkage of a top layer of a composite porous textile tile. A bottom or backside of the composite porous textile tile is converted into a thermoplastic layer using heat, and the thermoplastic layer is allowed to shrink and counterbalance the shrinkage of the top layer to avoid deformation of the composite textile tile into an objectionable concave shape as temperatures and pressures vary during installation or use. In one embodiment, converting the backside includes applying heat using radiant heating or contact heating at a high temperature and melting an outer stratum at the backside. The resulting thermoplastic layer is allowed to shrink by cooled ironing the thermoplastic layer to form a fused crust at the bottom of the composite porous textile tile. In one embodiment, cooled ironing is performed by a cooled roller.

Exemplary embodiments are directed to a method for counterbalancing tile shrinkage to prevent warping of edges out of plane. A tile having a topside and a backside opposite the topside is selected. In one embodiment, the tile further includes a plurality of edges extending from the topside to the backside. In one embodiment, a compliant fibrous felt backing is selected. In one embodiment, a tile having a fibrous structure with the backside having a fibrous surface is selected. In one embodiment, the topside of the tile is a solid polymeric material.

At least of portion of the backside is covered with a material that imparts a backside shrinking force along the backside in at least one direction across the backside. The topside develops a topside shrinking force along the topside in response to variations in ambient conditions. Suitable ambient conditions include temperature, humidity or temperature and humidity. In one embodiment, the backside shrinking force counterbalances the topside shrinking force. In one embodiment, the backside shrinking force is sufficient to form a convex shape in the tile when viewed from the topside.

In one embodiment, the material is a pressure sensitive adhesive. In one embodiment, to cover at least the portion of the backside a shrinkable material is attached to at least the portion of the backside. The shrinkable material is allowed to shrink to impart the backside force to the tile. In one embodiment, the shrinkable material is attached by heating the shrinkable material and depositing the heated shrinkable material to the backside of the tile. To allow the shrinkable material to shrink, the heated shrinkable material is allowed to cool in situ. In one embodiment, the shrinkable material is a polymer layer, a thermoplastic film, a woven polymeric fabric, a non-woven polymeric fabric, or cross-bonded scrim. In one embodiment, to attach the shrinkable material an elastic material under tension is attached to the backside of the tile. Allowing the shrinkable material to shrink involves releasing the tension to allow the elastic material to shrink.

In one embodiment, a heated breathable membrane is attached to the backside using an intermediate adhesive layer. In one embodiment, a polymeric layer is attached to the backside of the tile, and the polymeric layer is needle punched to the backside of the tile. The temperature of the tile adjacent the backside is raised under restraint. The shrinkable material is allowed to shrink by cooling the tile under reduced restraint to shrink the polymeric layer. In one embodiment, a dual coextruded high melt/low-melt film is attached to the backside of the tile at an elevated temperature. In one embodiment, the shrinkable material is attached by applying molten pressure sensitive adhesive to a porous surface of the backside of the tile and allowing the molten pressure sensitive adhesive to penetrate into pores in the porous surface of the backside at least partially. The shrinkable material is allowed to shrink by cooling the molten pressure sensitive adhesive.

In one embodiment the backside has a porous surface containing pores, and attaching the shrinkable material include attaching a polymeric sublayer to the backside and engaging at least a portion of the pores in the porous surface. In one embodiment, at least of portion of the backside is covered with the material by depositing a plurality of discrete lines of the material. In one embodiment, the plurality of discrete lines of the material is a plurality of separate yarns of the material. In one embodiment, depositing the plurality of discrete lines of the material includes depositing a plurality of parallel rectilinear lines, a plurality of parallel curvilinear lines or an undulating pattern of lines. In one embodiment, depositing the plurality of discrete lines of the material includes depositing a combination of a plurality of parallel rectilinear lines, a plurality of parallel curvilinear lines and an undulating pattern of lines. In one embodiment, depositing the plurality of discrete lines of the material includes depositing a crossing pattern of the plurality of discrete lines. In one embodiment, depositing the plurality of discrete lines of the material includes spacing adjacent discrete lines from each other across the backside.

In one embodiment, covering at least of portion of the backside with the material includes covering at least a portion of the backside with a contiguous layer of the material. In one embodiment, the contiguous layer of the material is a solid layer or a porous layer. In one embodiment, covering at least of portion of the backside with the material includes concentrating the material adjacent one or more of the plurality of edges.

Exemplary embodiments are also directed to a method for counterbalancing tile shrinkage. A face layer having a topside that develops a topside shrinking force along the topside in response to variations in ambient conditions is selected, and a backing layer is attached to the face layer opposite the topside to form a composite porous textile tile. A backside of the backing layer opposite the face layer is heated to convert the backside into a thermoplastic layer, and the thermoplastic layer is allowed to shrink and to impart a backside shrinking force along the backside in at least one direction across the backside. The backside shrinking force counterbalances the topside shrinking force as ambient conditions vary to prevent deformation of the tile. In one embodiment, the backside is heated using radiant heating or using contact heating to melt an outer strata of the backing layer at the backside. In addition, the thermoplastic layer is allowed to shrink by ironing the thermoplastic layer with a cooled surface to form a fused crust at the backside. In one embodiment, the cooled surface is a cooled roller.

Exemplary embodiments are directed to a floorcovering tile with a topside that develops a topside shrinking force along the topside in response to variations in ambient conditions, a backside opposite the topside and a material covering at least a portion of the backside. The material imparts a backside shrinking force along the backside in at least one direction across the backside. The backside shrinking force is sufficient to counter balance the topside shrinking force.

### FIGURES

FIG. 1 is schematic representation of the cross section of a prior art textile tile with an attached top surface layer after changes in ambient conditions cause curling;

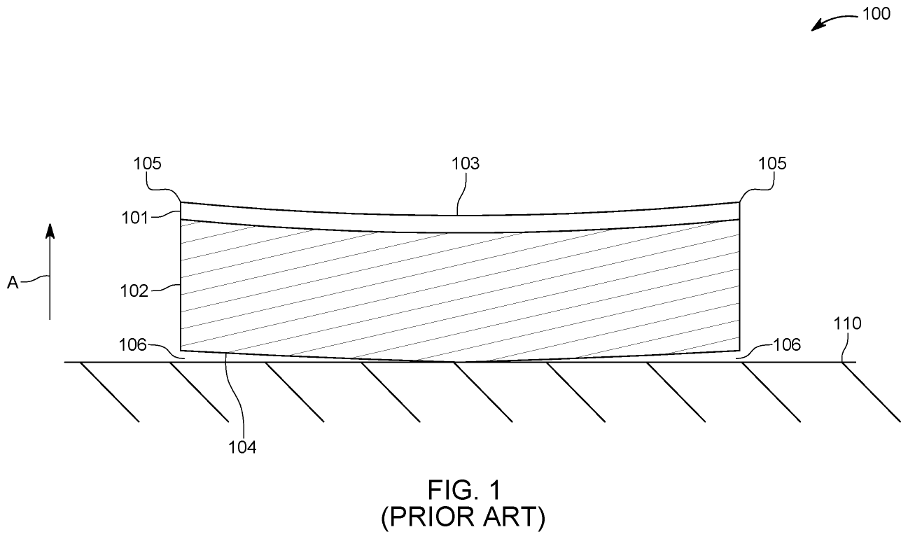

FIG. 2 is a schematic representation of an embodiment of a cross section of a tile with a surface layer and a material on the backside of the tile;

FIG. 3 is a schematic representation of an embodiment of a cross section of a tile with a surface layer and a material on the backside of the tile that assumes a slightly domed shape;

FIG. 4 is a schematic representation of an embodiment of a cross section of a tile with a surface layer and a material on the backside of the tile attached to a surface;

FIG. 5 is a schematic representation of and embodiment of the backside of a tile with an array of lines of material aligned in a longitudinal direction;

FIG. 6 is a schematic representation through line 6-6 of FIG. 5 after the lines of material are allowed to cool;

FIG. 7 is the schematic representation of an embodiment of the backside of a tile with an array of lines of material aligned in a cross direction;

FIG. 8 is a schematic representation through line 6-6 of FIG. 7 after the lines of material are allowed to cool;

FIG. 9 is an illustration of an embodiment of lines of material on the backside of a tile in a sinusoidal arrangement;

FIG. 10 is an illustration of an embodiment of lines of material on the backside of a tile arranged as both sinusoidal shaped lines and rectilinear lines;

FIG. 11 is an illustration of an embodiment of lines of material on the backside of a tile arranged in discontinuous interconnected line segments;

FIG. 12 is an illustration of an embodiment of lines of material on the backside of the tile arranged as lines extending in both the longitudinal and cross directions;

FIG. 13 is an illustration of an embodiment of lines of material on the backside of the tile arranged as lines extending in two diagonal directions;

FIG. 14 is an illustration of an embodiment of lines of material on the backside of the tile arranged as lines concentrated along the four edges;

FIG. 15 is an illustration of an embodiment of lines of material on the backside of the tile arranged in a plaid pattern;

FIG. 16 is illustration of an embodiment of lines of material on the backside of the tile arranged in a pattern across the four corners; and

FIG. 17 is a schematic representation of an embodiment of a method for counterbalancing tile shrinkage by converting the backside of a thermoplastic textile tile a fused and densified polymeric layer.

### DETAILED DESCRIPTION

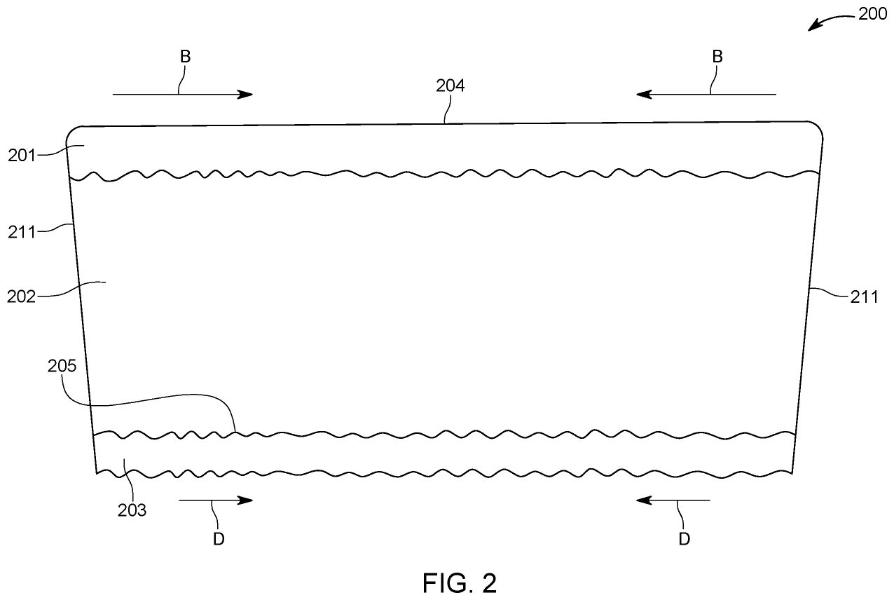

Exemplary embodiments are directed to a method for counterbalancing tile shrinkage. Referring to FIG. 2, a tile 200 is selected. In one embodiment, the method includes creating or forming the tile. Suitable tiles include, but are not limited to, flooring tiles and wall covering tiles. In one embodiment, a compliant fibrous felt backing is selected. In one embodiment, a tile having a fibrous structure and a bottom or backside having a fibrous surface is selected. The tile can be a single layer of material or can be a composite containing a plurality of layers, e.g., two, three or more layers. In general, the tile includes a top surface or topside 204 and a back surface or backside 205 opposite the topside. In one embodiment, the topside of the tile is a solid polymeric material. As illustrated, the tile contains two layers, a face layer 201 containing the topside 204 and a compliant backing 202 attached to the face layer opposite the topside and containing the backside 205.

The tile also includes a plurality of edges 211 extending from the topside to the backside. A rectangular or square tile includes four edges. When installed, the edges of adjacent tiles touch. The topside 204 develops a topside shrinking force or contracting force along the topside in response to variations in ambient conditions. In one embodiment, the ambient conditions include temperature, humidity or temperature and humidity. The topside shrinking force can extend along the topside in one or more directions. The topside shrinking force extends along the topside inward from the edges as illustrated by arrows B. This pulls opposite edges inward and toward each other along the topside, producing up-curl in the tile.

In one embodiment, at least a portion of the area of backside is covered with a material 203, e.g., a shrinking or shrinkable material, that imparts a backside shrinking force along the backside in at least one direction across the backside. This backside shrinking force pulls inward on the edges of the tile along the backside, for example, as indicated by arrows D. The backside shrinking force counterbalances the topside shrinking force to prevent or to correct up-curl in the tile. Any suitable material that expands and contracts in at least one dimension can be used. In one embodiment, the material expands and contracts when exposed to heat. Suitable materials include, but are not limited to, polymers, pressure sensitive adhesives, elastomers and elastics. These materials can be applied as polymeric films, polymeric coatings including pressure sensitive coatings applied in hot molten form, fusible non-woven webs, arrays of polymeric yarns attached while hot or elastic and under tension, a thermoplastic film, a woven polymeric fabric, a non-woven polymeric fabric, and a cross-bonded scrim. In one embodiment, the material is heated to a desired temperature and is attached to the backside while heated, for example using a separate adhesive. In one embodiment, heating of the material is continued until the material is attached to the backside.

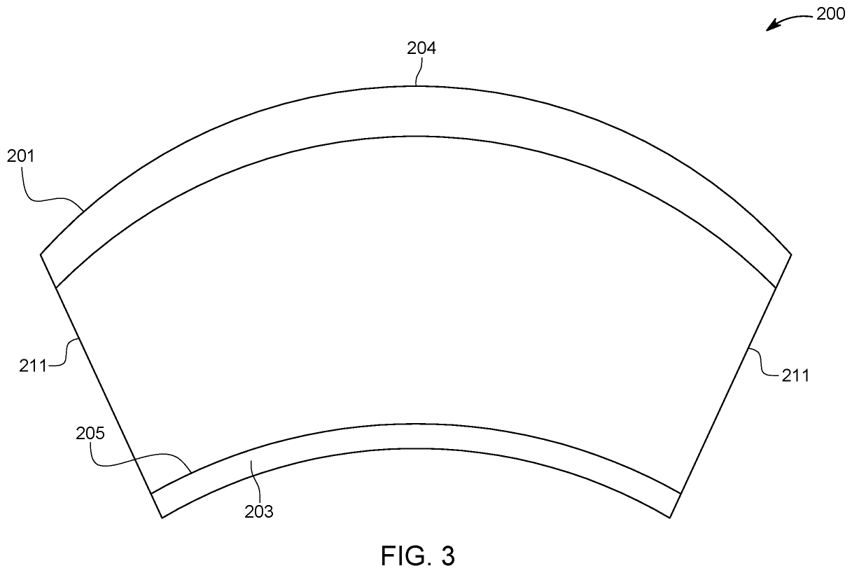

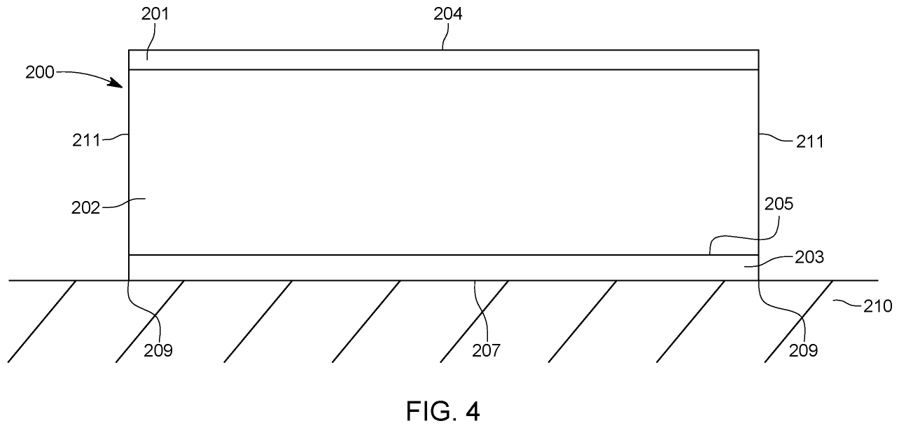

Following attachment to the backside, the material is allowed to shrink or contract, for example, by allowing the material to cool. Referring to FIG. 3, in one embodiment, the backside shrinking force is sufficient to form a convex or slightly domed shape in the tile when viewed from the topside. In one embodiment, this backside shrinking force forms the convex or domed shape before a topside shrinking force develops. Referring now to FIG. 4, the resulting composite of the tile and attached material is placed on a surface 210, for example, the floor, with the sublayer contacting the floor. Given the domed shape, the edges 209 of the sublayer contact the surface first. In one embodiment, adhesive is applied between the material and the backside and the surface and is used to hold the center 207 of the tile and material against the surface, i.e., in a flat configuration. Alternatively, pressure from the weight of the tile itself holds the tile and material flat against the surface. The tile containing the material that produces a backside shrinking force sufficient to produce the domed shape counteracts the tendency of the edges 209 to rise off the surface, i.e., up-curl, as the top layer 201 shrinks with changes in ambient conditions.

As discussed herein, a material, e.g., a shrinkable material, is attached to at least a portion of the backside of the tile, covering at least a portion of the area of the backside. The material is allowed to shrink to impart the backside shrinking force to the tile. The steps and methods for attachment and shrinking of the material vary depending on the material and the pattern of attachment. In one embodiment, the shrinkable material is heated, and the heated shrinkable materials is deposited or placed on the backside of the tile. To shrink the shrinkable material, the heated shrinkable material is allowed to cool in situ, i.e., on the backside of the tile. In one embodiment, the shrinkable material is an elastic material, and the elastic material is attached under tension, i.e., while being at least partially stretched, to the backside of the tile. The tension is released to allow the elastic material to contract or shrink.

In one embodiment, the material is a breathable membrane, and the breathable membrane is heated. Suitable breathable membranes include, but are not limited to, a solid film with very fine perforations, an open-cell foamed sheet, and a microfiber nonwoven. The heated breathable membrane is attached to or placed on the backside using a separate intermediate adhesive layer. In one embodiment, this separate intermediate adhesive layer, after melting, is amorphous and mostly absorbed by the heated outer breathable membrane and the bottom layers of the flooring tile. In one embodiment, the weight, melt viscosity and surface continuity of the separate intermediate adhesive layer are adjusted to prevent the separate intermediate adhesive layer from excessively blocking openings in the breathable membrane or in the bottom of the flooring tile.

In one embodiment, the material is polymeric material that is attached to or placed against the backside of the tile as a polymeric layer. The polymeric layer is needle punched to the backside of the tile, and the temperature of the tile adjacent the backside is heated under restraint. The tile containing the heated, needle punched polymeric layer is then cooled under reduced restraint to shrink the polymeric layer and to cause the flooring tile to assume a slightly convex configuration.

In one embodiment, the material is a dual coextruded high-melt/low-melt film. As used herein, the dual coextruded high-melt/low-melt film includes two sides, a high-melt side and a low-melt side. The low-melt side functions as the adhesive, and the high-melt side is the added layer or material that tends to shrink after the dual film is attached. The dual film is attached to the backside of the tile at an elevated temperature above the melting temperature of the low-melt side. The high-melt side then shrinks and causes the flooring tile to assume a slightly convex or domed shape.

In one embodiment, the material is a pressure sensitive adhesive that is heated into a molten form. The molten pressure sensitive adhesive is applied to the backside of the tile, which has a porous surface. The molten pressure sensitive adhesive is allowed to penetrate into the pores in the porous surface of the backside at least partially. The molten pressure sensitive adhesive is then allowed to cool and shrink. In one embodiment, the material is a polymer and, the backside is a porous surface containing a plurality of pores. The polymer is attached to the backside as a polymeric sublayer such that the polymeric sublayer engages pores in the porous surface. The polymeric sublayer is then allowed to shrink, for example, by cooling.

For any type of material or steps for attaching the material to the backside of the tile and shrinking the material, the material is attached to and covers at least a portion of the backside, i.e., covers at least a portion of area of the backside. Exemplary embodiments include solid or contiguous layers or films heated and applied over the entire backside surface, with or without the use of adhesives. In one embodiment, the portion of the backside is a single contiguous portion. Alternatively, the portion of the backside contains a plurality of separate and independent sections. In one embodiment, the backside is covered with a contiguous layer of the material. Preferably, the contiguous layer of material covers the entire backside of the time. The contiguous layer of the material is a solid layer or a porous layer.

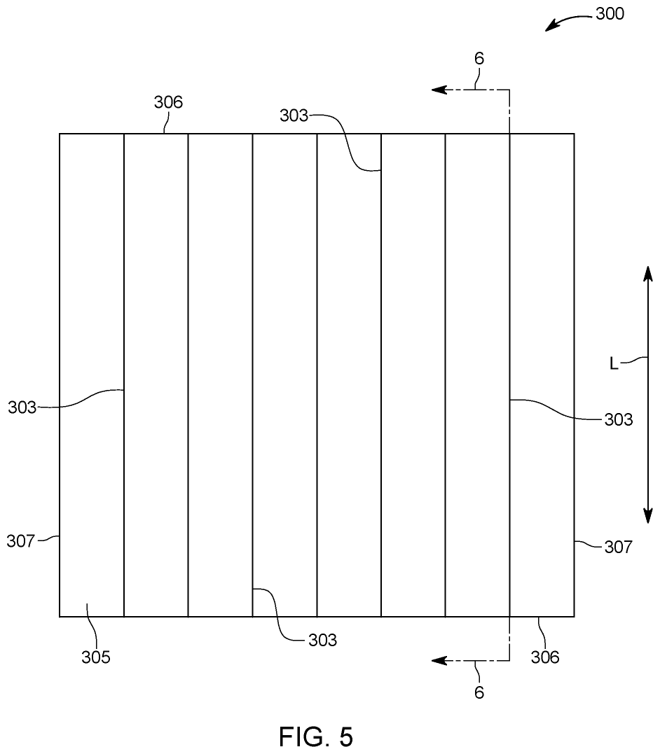

Covering at least of portion of the backside with the material includes geometries and arrangements of material that target the location and direction of the backside shrinking force. In one embodiment, the material is deposited as a plurality of discrete lines of the material. In one embodiment, the plurality of discrete lines of the material are formed from a plurality of separate yarns of the material. In one embodiment, the plurality of discrete lines of the material are separate and distinct lines of material, and adjacent discrete lines are spaced from each other across the backside. The adjacent discrete lines can be spaced from each other by the same distance or by distances that vary across the backside. Referring now to FIG. 5, an exemplary embodiment of a material attached to at least a portion of the backside 305 of a tile 300 is illustrated. As illustrated, the material is attached as a plurality of parallel rectilinear lines 303, e.g., strips or yarns, of material extending in a given longitudinal direction L across or along the backside. As illustrated, the longitudinal direction is parallel to one of the sides 307 of the tile. In one embodiment, the lines of material are spaced from the sides. Alternatively, a line of material extends along each one of a pair of sides 307. As illustrated, adjacent lines are equally spaced from each other across the backside.

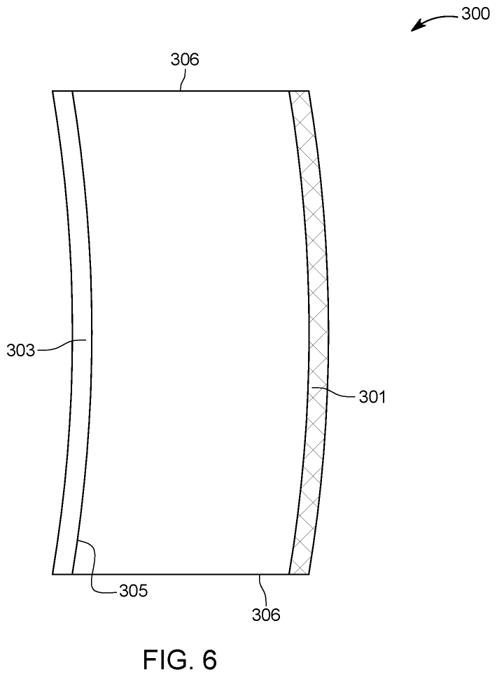

The backside shrinking force applied to the tile extends along each line inward from the edges. Longitudinal or machine directional counteracting arrangements of lines of material are suitable for tiles manufactured in a process involving heat applied to the top surface and cooled while under longitudinal stress. Residual longitudinal stress causes the top side or face layer to shrink with a drop in temperature, curling the tile up along the cross-directional edges 306. Parallel rectilinear lines of material that are attached while hot and then are cooled and contracted thermally in situ or parallel rectilinear lines of elastic material that are attached under stress and shrunk elastically in situ after attachment provide a counteracting force along the longitudinal direction. Referring to FIG. 6, this counteracting longitudinal force produces a slight pre-doming inward or upward in the tile and face layer 301 from the cross-directional edges 306, counteracting the tendency of the edges to curl upwards.

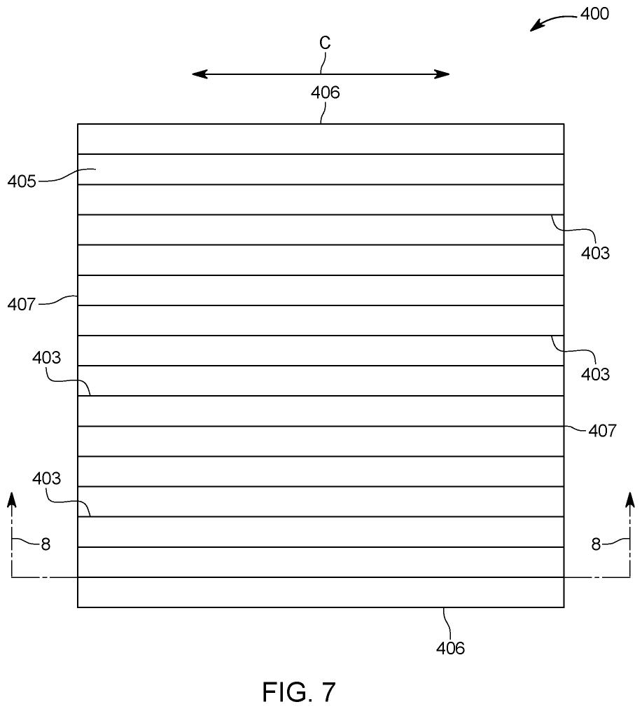

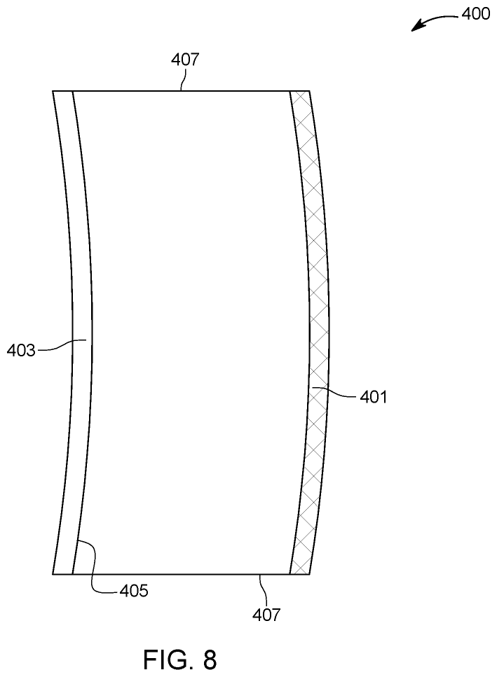

Referring now to FIG. 7, an exemplary embodiment of a material attached to the backside 405 of a tile 400 as a plurality of parallel rectilinear lines 403 of material extending in a given cross-direction C, or XD, across the backside is illustrated. As illustrated, the cross-direction is parallel to one of the sides 406, or pairs of sides, of the tile and is perpendicular to the longitudinal edges 607 or longitudinal or machine direction. This arrangement is preferred if the top side or face layer is cooled under cross-directional restraint during manufacture, which can produce curling or doming in the machine or longitudinal direction. In one embodiment, the parallel rectilinear lines of material provide a counteracting backside shrinking force along the lines of material in the cross-direction, for example, by elastic shrinkage or thermal contraction. Referring to FIG. 8, this counteracting cross-directional force produces a slight pre-doming inward or upward toward the face layer 401 from the longitudinal edges 407, counteracting the tendency of the edges to curl upwards as temperature or humidity vary, for example, after installation on a floor.

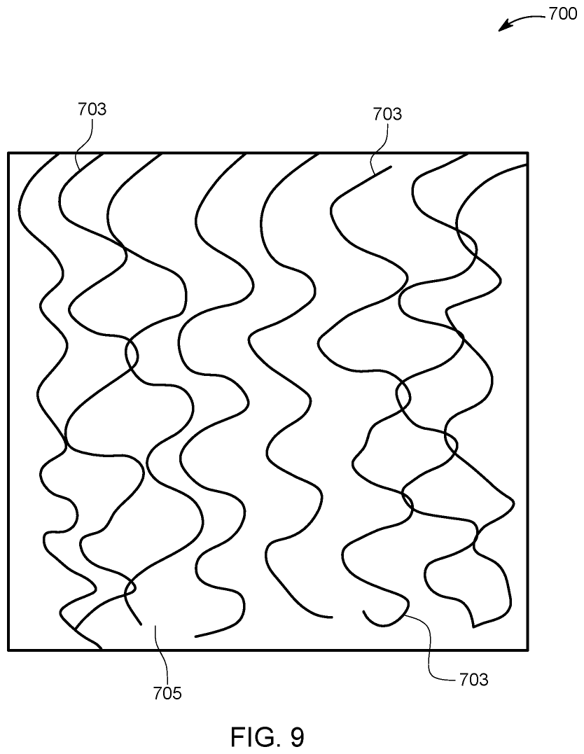

In general, the plurality of discrete lines of the material can be deposited as a plurality of parallel rectilinear lines, a plurality of parallel curvilinear lines or an undulating pattern of lines. In one embodiment, the plurality of discrete lines of the material is deposited as a combination of a plurality of parallel rectilinear lines, a plurality of parallel curvilinear lines and an undulating pattern of lines. Referring now to FIG. 9, in one embodiment, a plurality of non-rectilinear yarns 703 of material is disposed across the backside 705 of the tile 700 in at least one direction. As illustrated, each line has a curved, undulating or sinusoidal shape, and the lines can overlap or cross. This arrangement provides counteracting forces against warping in all directions across the backside.

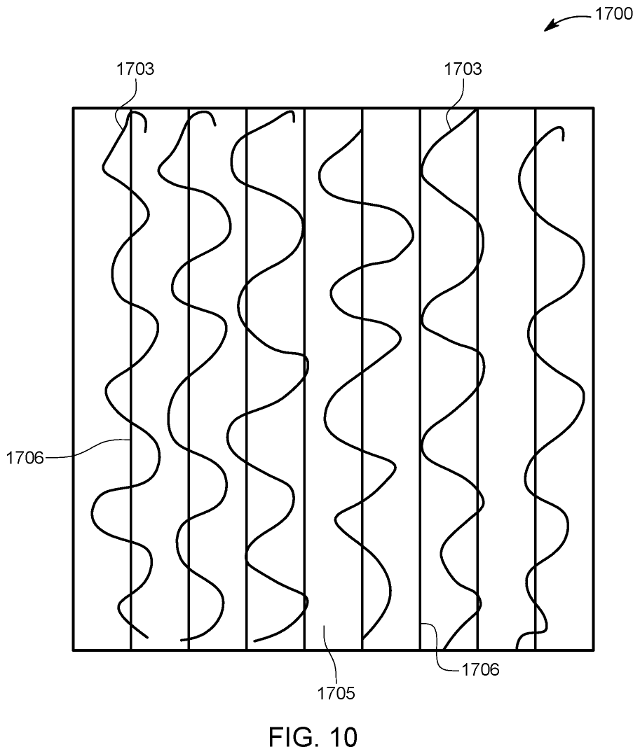

Referring now to FIG. 10, in one embodiment, the lines of material, e.g., yarns, are attached to the backside 1705 of the tile 1700 as a first set of lines 1703 having the sinusoidal shape and a second set of lines 1705 crossing the first set of lines and arranged as a plurality of rectilinear parallel lines of material. In one embodiment, the first and second sets of lines of material extend across the backside in a common direction. Alternatively, the first and second sets of lines extend across the backside in different directions, intersecting each other at a desired angle.

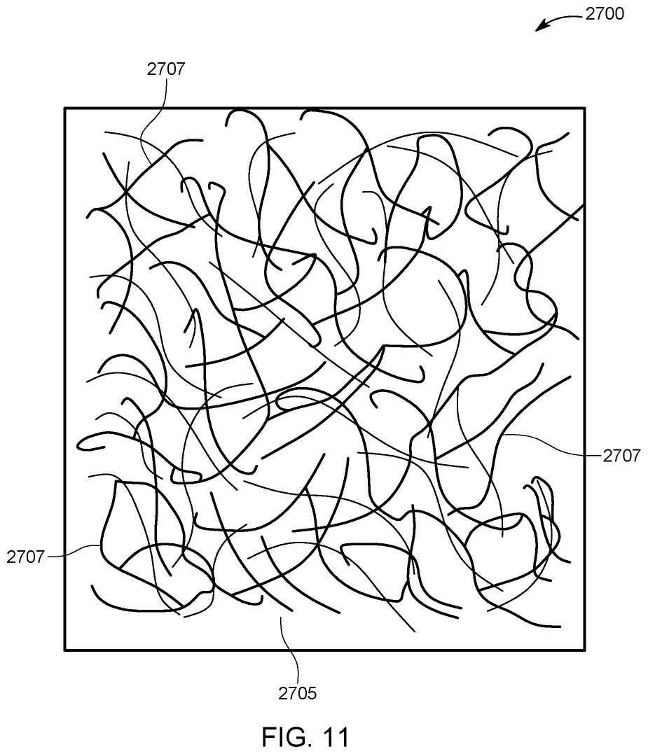

Referring now to FIG. 11, in one embodiment the plurality of lines 2707 are arranged as short segments of straight or curved lines, e.g., short segments of yarns, placed across the backside 2705 of the tile 2700 in accordance with a random pattern. Suitable short segments of lines of material include short yarns made from a shrinkable material. In one embodiment, the plurality of lines of material includes shorter intercrossing line segments or fibrous lengths. In one embodiment, the density of the lines in the random pattern is varied across the backside to adjust the amount or magnitude of the backside shrinking force across the backside.

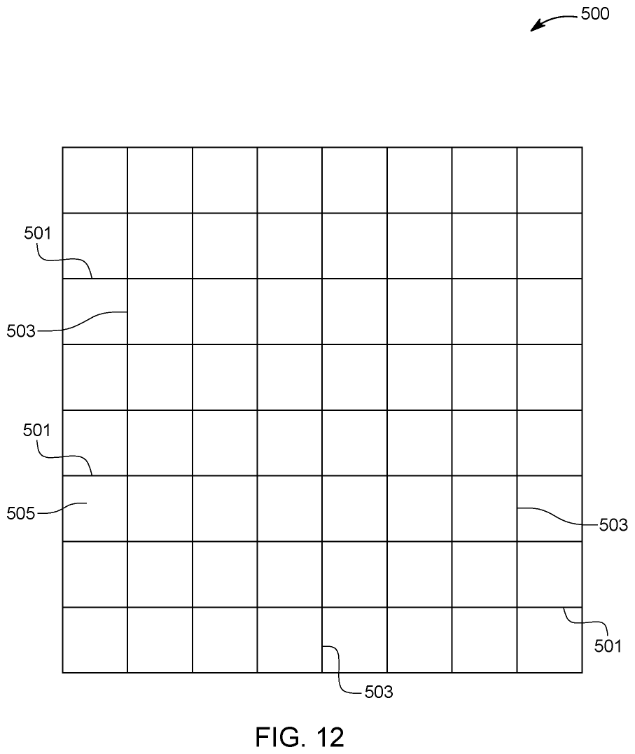

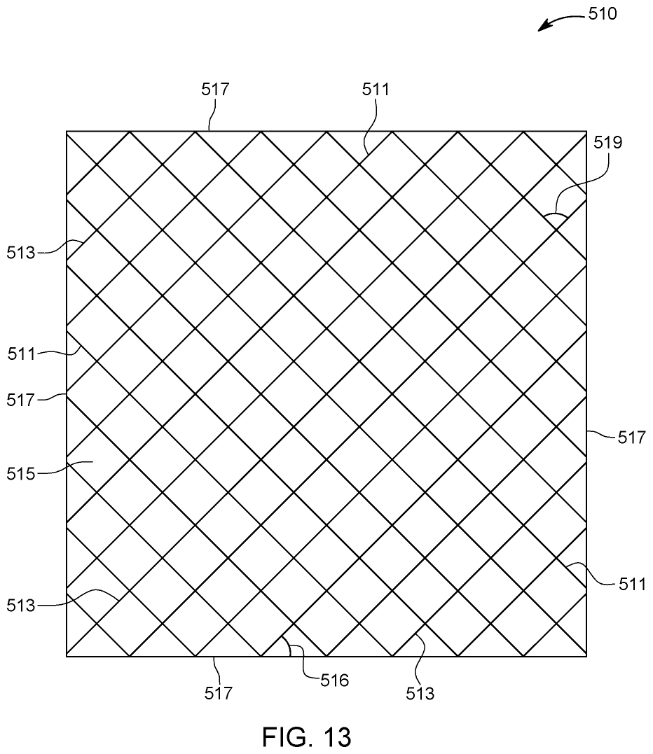

In one embodiment, the plurality of discrete lines of the material is deposited as a crossing pattern of discrete lines. This cross pattern of discrete lines of material is used to create counter-acting backside shrinking forces in both the longitudinal direction and the cross-direction across the backside of the tile. Referring to FIG. 12, in one embodiment, the backside 505 of the tile 500 includes a first plurality of parallel rectilinear lines of material 503 placed across the backside in a first direction, for example, the longitudinal direction, and a second plurality of parallel rectilinear lines of material 501 placed across the backside in a second direction, for example, the cross-direction. The first and second lines of material cross and are perpendicular to each other. However, the first and second lines can cross at angles less than 90 degrees. Referring now to FIG. 13, the first and plurality of parallel rectilinear lines of material 513 and the second plurality of parallel rectilinear lines of material 511 extend across the backside 515 of the tile and are maintained in the mutually perpendicular arrangement. However, the resulting grid of rectilinear lines is rotated, changing an angle 516 at which the rectilinear lines intersect one of more of the edges 517 of the tile. Varying this angle varies the amount of counter-acting backside shrinking force contributed by the arrangement of rectilinear lines of material in either the longitudinal or cross-direction. In addition to or as an alternative to varying the angle at which the rectilinear lines of material intersect the edges, the angle 519 between individual rectilinear lines in the first and second sets of parallel lines can also be changed to vary the resulting counter-acting forces. This angle can be varied with the individual rectilinear lines parallel to the edges of the tile or intersecting the edges of the tile at an angle less than 90 degrees.

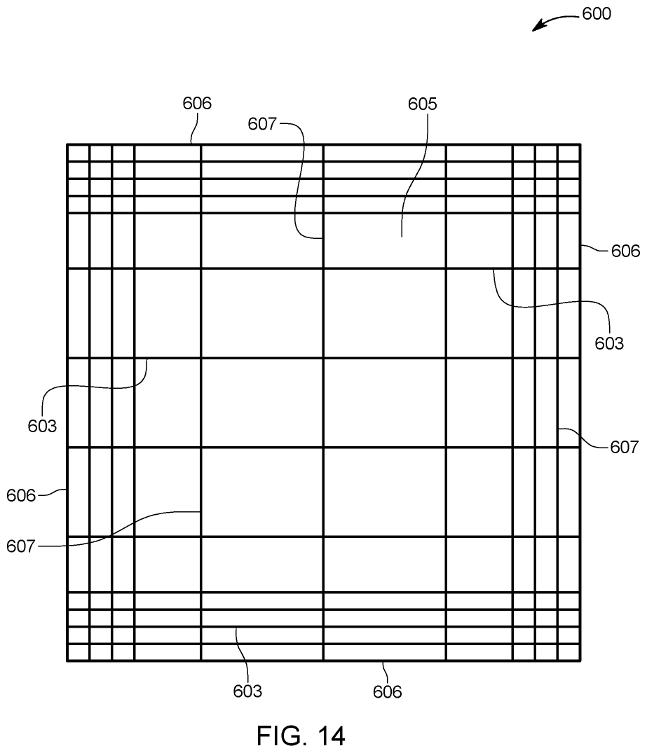

In addition to patterns of lines of material that uniformly cover at least of portion of the backside of the tile, variable patterns of lines of material are used. In one embodiment, the plurality of lines of material is concentrated adjacent one or more of the plurality of edges. Referring now to FIG. 14, a first plurality of parallel rectilinear lines of material 607 are placed across the backside 605 of the tile 600 in a first direction, for example, the longitudinal direction, and a second plurality of parallel rectilinear lines of material 603 are placed across the backside in a second direction, for example, the cross-direction. These two sets of parallel rectilinear lines cross and are perpendicular to each other; however, the rectilinear lines in each set are not spaced evenly from each other across the backside. The rectilinear lines of material in each set are spaced closer together adjacent the edges 606 and are spaced farther apart in the middle of the backside of the tile. In one embodiment, the spacing between adjacent lines in each set decreases as the lines approach the edges. Therefore, spacing between adjacent parallel rectilinear lines is greater in the center of the tile, and the number of lines of material per unit length or unit area is greater adjacent the edges.

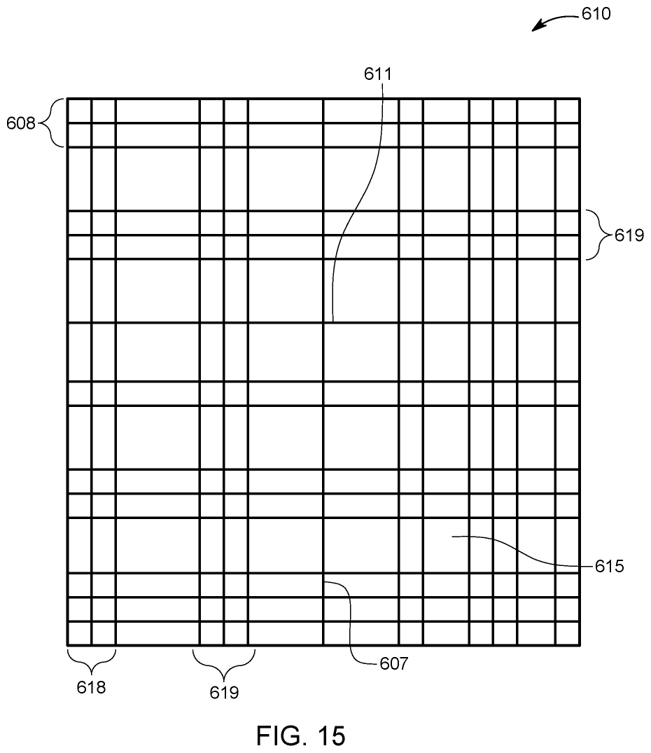

In addition to arrangements of rectilinear lines of material in two or more directions across the backside of the tile with varying orientations and angles among the rectilinear lines, the spacing between adjacent lines of material and the coverage of the rectilinear lines are varied across the backside of the tile. Referring now to FIG. 15, the plurality of parallel rectilinear lines of material attached to the backside 615 of the tile 610 in both first plurality of parallel rectilinear lines of material 617 and the second plurality of parallel rectilinear lines of material 613 is arranged in a changing pattern, e.g., a plaid pattern, where the spacing between adjacent parallel lines of material is varied to create groups or clusters of lines of material. The number of lines of material in each cluster can be varied, for each cluster having three lines 619 and cluster having two lines 618. Clusters can have more than three lines of material. In one embodiment, the plaid pattern also includes one of more individual lines of material 611. The clusters and individual lines of material can be located in with the first or second sets of parallel rectilinear lines. The plaid pattern in each set of parallel rectilinear lines can be the same or can vary.

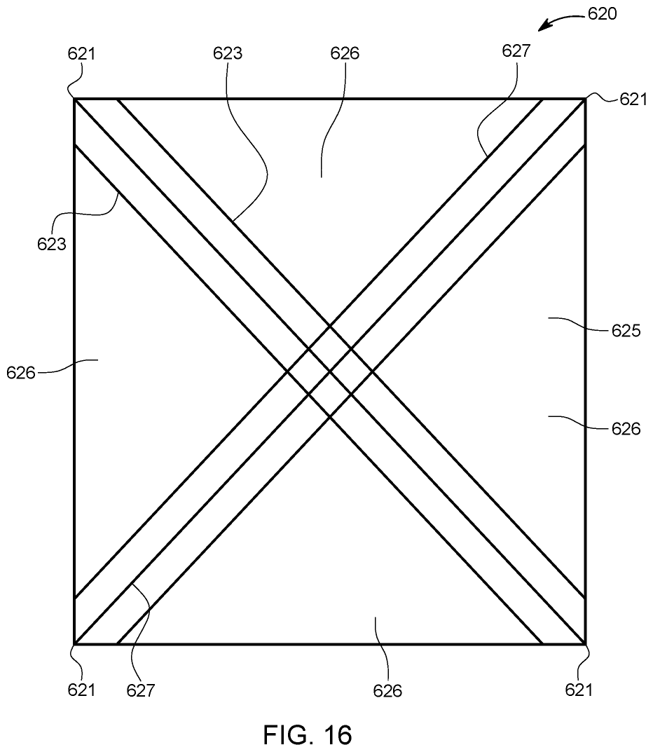

Referring now to FIG. 16, in one embodiment, first plurality of parallel rectilinear lines of material 627 and the second plurality of parallel rectilinear lines of material 623 are attached to the backside 625 of the tile 620 and are mutually perpendicular. The resulting grid of rectilinear lines is rotated to intersect the corners 621 of the backside of the tile, and the lines of material extend diagonally across the backside. In addition, only the lines of material intersecting the corners or disposed immediately adjacent the lines of material intersecting the corners are used. Therefore, the backside includes open areas 626 that are not covered with lines of material. The resulting backside shrinking force pulls in on the corners. This arrangement counteracts the tendency for up-curl in the corners of the tile. Suitable lines of material in any of the embodiments disclosed herein include strips or yarns of elastic material attached under tension and polymeric yarns attached while hot and shrunk in situ by simple thermal contraction.

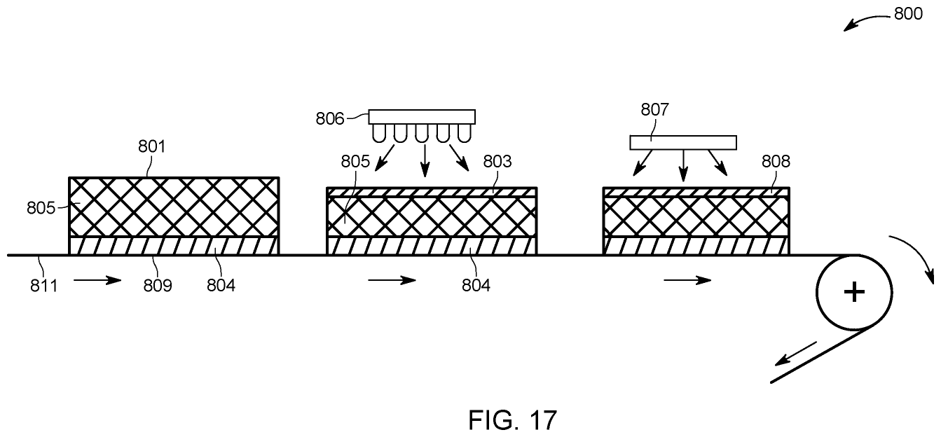

In addition to attaching material to the backside of the tile and allowing that material to shrink to generate the backside shrinking force, in one embodiment, the desired shrinkable material is formed from the tile. Referring now FIG. 17, a method for counterbalancing tile shrinkage by forming a thermoplastic material layer on the backside of a tile 800 is illustrated. As illustrated, the tile has a face layer 804 with a topside 809 and a backing layer 805 attached to the face layer opposite the topside. While illustrated with two layers, a tile with a single layer or a two with three or more layers can be used. In order to form the tile, a face layer that develops a topside shrinking force along the topside in response to variations in ambient conditions is selected. The backing layer is attached to the face layer opposite the topside to form a composite porous textile tile. In one embodiment, the backing layer is a thermoplastic backing. In one embodiment, the resulting tile is placed on a conveying mechanism 811, for example, a conveyor belt, with the topside of the face layer in contact with the conveying mechanism and the backside 801 of the backing layer exposed.

The conveying mechanism conveys the tile past a heat source 806 that exposes the back surface to heat sufficient to melt the back surface and to form a melted layer 803 covering at least a portion of the backside. Suitable heat sources include, but are not limited to, radiant heating sources, conductive heating sources and convective heating sources. In one embodiment, contact heating is used to melt an outer strata of the backing layer at the backside. The conveying mechanism then conveys the tile past a cooling source 807. Suitable cooling sources include forced air, either at ambient temperatures or at temperatures below the ambient temperature, that is directed onto the back side. In one embodiment, cooling and allowing the melted layer to shrink is accomplished by ironing the melted layer with a cooled surface to form a fused crust at the backside. In on embodiment, the cooled surface is a cooled roller. Exposure to the cooling source is sufficient to cool the melted layer in situ and to allow the melted layer to shrink, forming a fused material 808, e.g., a fused thermoplastic layer, that imparts the desired backside shrinking force along the backside in at least one direction across the backside. The backside shrinking force is sufficient to counterbalance the topside shrinking force as ambient conditions vary to prevent deformation of the tile. While the method conveys the tile past the heating and cooling sources, in one embodiment, the tile remains stationary and the heating and cooling sources are moved over or into position over the backside. In one embodiment, the heating sources is moved over the backside in accordance with the desired pattern of material.

In one embodiment, the lines of material, for example, as illustrated in the figures, are wider strips or lines of material of any shape that reach edge to edge, forming square or rectangular lines and spaces throughout the back surface of the tile. Exemplary embodiments utilize lines or strips of a polymer concentrated along the tile edges, arranged in uniform patterns or arranged in variable patterns such as plaid patterns, as illustrated in any of the embodiments and arrangements described herein. Exemplary embodiments include arrangements of warps or warps and wefts of elastomeric or non-elastomeric strips or yarns attached to the backside of a tile under tension and allowed to cool in situ. Exemplary embodiments include warps, wefts or warps and wefts of heat-shrinkable partially-oriented yarns (POY) attached to the backside of a soft felt backing with or without applying tension. The strips or yarns may be attached using adhesives, pattern bonding at intervals, or needle-punching. The resulting structure is post activated with heat applied to the backside of the tile and allowed to cool in situ.

Exemplary embodiments utilize molten polymer applied over the whole surface or in a pattern of lines or strips of hot polymer attached simultaneously in both directions or separately in each of two or more directions. In one embodiment molten pressure sensitive adhesive (PSA) is applied to a porous backside, and the hot PSA partly engages the fibrous or non-fibrous surface of the backside. The remainder of the tile that is not engaged with the PSA remains free as the bottom layer shrinks along with the solidifying and shrinking PSA. This tends to force the tile into a slightly convex domed shape. This embodiment is particularly successful in controlling up-curl as the thermal forces resisting up-curl are also adhesive. The PSA can be applied to the backside in a pattern that is contiguous and uniform, contiguous but variable, or in a pattern that includes lines or strips reaching the edges of the tile as illustrated herein, a plaid pattern, or in a pattern of interconnecting lines or strips.

Exemplary embodiments include slip resistant layers or stripe patterns such as rubber, attached at a high temperature to the backside of a tile and allowed to cool under low restraint or with no restraint.

The foregoing written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for counterbalancing tile shrinkage to prevent warping of edges out of plane, the method comprising:
selecting a tile comprising a topside and a backside opposite the topside; and
covering at least of portion of the backside with a material that imparts a backside shrinking force along the backside in at least one direction across the backside.

2. The method of claim 1, wherein:
the topside develops a topside shrinking force along the topside in response to variations in ambient conditions; and
the backside shrinking force counterbalances the topside shrinking force.

3. The method of claim 2, wherein the ambient conditions comprise temperature, humidity or temperature and humidity.

4. The method of claim 1, wherein covering at least the portion of the backside comprises:
attaching a shrinkable material to at least the portion of the backside; and
allowing the shrinkable material to shrink to impart the backside force to the tile.

5. The method of claim 4, wherein:
attaching the shrinkable material comprises:
heating the shrinkable material; and
depositing the heated shrinkable material to the backside of the tile; and
allowing the shrinkable material to shrink comprises allowing the heated shrinkable material to cool in situ.

6. The method of claim 5, wherein the shrinkable material comprises a polymer layer, a thermoplastic film, a woven polymeric fabric, a non-woven polymeric fabric, or cross-bonded scrim.

7. The method of claim 4, wherein:
attaching the shrinkable material comprises attaching an elastic material under tension to the backside of the tile; and
allowing the shrinkable material to shrink comprises releasing the tension to allow the elastic material to shrink.

8. The method of claim 4, wherein attaching the shrinkable material comprises attaching a heated breathable membrane to the backside using an intermediate adhesive layer.

9. The method of claim 4, wherein:
attaching the shrinkable material comprises:
attaching a polymeric layer to the backside of the tile;
needle punching the polymeric layer to the backside of the tile; and
raising a temperature of the tile adjacent the backside under restraint; and
allowing the shrinkable material to shrink comprises cooling the tile under reduced restraint to shrink the polymeric layer.

10. The method of claim 4, wherein attaching the shrinkable material comprises attaching a dual coextruded high melt/low-melt film to the backside of the tile at an elevated temperature.

11. The method of claim 4, wherein:
attaching the shrinkable material comprises:
applying molten pressure sensitive adhesive to the backside of the tile, the backside comprising a porous surface; and
allowing the molten pressure sensitive adhesive to penetrate into pores in the porous surface of the backside at least partially; and
allowing the shrinkable material to shrink comprises cooling the molten pressure sensitive adhesive.

12. The method of claim 4, wherein:
the backside comprises a porous surface containing pores; and
attaching the shrinkable material comprises:
attaching a polymeric sublayer to the backside; and
engaging at least a portion of the pores in the porous surface.

13. The method of claim 1, wherein covering at least of portion of the backside with the material comprises depositing a plurality of discrete lines of the material.

14. The method of claim 13, wherein the plurality of discrete lines of the material comprise a plurality of separate yarns of the material.

15. The method of claim 13, wherein depositing the plurality of discrete lines of the material comprises depositing a plurality of parallel rectilinear lines, a plurality of parallel curvilinear lines or an undulating pattern of lines.

16. The method of claim 13, wherein depositing the plurality of discrete lines of the material comprises depositing a combination of a plurality of parallel rectilinear lines, a plurality of parallel curvilinear lines and an undulating pattern of lines.

17. The method of claim 13, wherein depositing the plurality of discrete lines of the material comprises depositing a crossing pattern of the plurality of discrete lines.

18. The method of claim 13, wherein depositing the plurality of discrete lines of the material comprises spacing adjacent discrete lines from each other across the backside.

19. The method of claim 1, wherein covering at least of portion of the backside with the material comprises covering at least a portion of the backside with a contiguous layer of the material.

20. The method of claim 19, wherein the contiguous layer of the material comprises a solid layer or a porous layer.

21. The method of claim 1, wherein:
the tile further comprising a plurality of edges extending from the topside to the backside; and
covering at least of portion of the backside with the material comprises concentrating the material adjacent one or more of the plurality of edges.

22. The method of claim 1, wherein the backside shrinking force is sufficient to form a convex shape in the tile when viewed from the topside.

23. The method of claim 1, wherein the material comprises pressure sensitive adhesive.

24. The method of claim 1, wherein selecting the tile comprises selecting a compliant fibrous felt backing.

25. The method of claim 1, wherein selecting the tile comprises selecting a tile comprising a fibrous structure with the backside comprising a fibrous surface.

26. The method of claim 1, wherein the topside of the tile comprises a solid polymeric material.

27. A method for counterbalancing tile shrinkage, the method comprising:
selecting a face layer comprising a topside that develops a topside shrinking force along the topside in response to variations in ambient conditions;
attaching a backing layer to the face layer opposite the topside to form a composite porous textile tile;
heating a backside of the backing layer opposite the face layer to convert the backside into a thermoplastic layer; and
allowing the thermoplastic layer to shrink and to impart a backside shrinking force along the backside in at least one direction across the backside, that backside shrinking force counterbalancing the topside shrinking force as ambient conditions vary to prevent deformation of the tile.

28. The method of claim 27, wherein:
heating the backside comprises using radiant heating or using contact heating to melt an outer strata of the backing layer at the backside; and
allowing the thermoplastic layer to shrink comprises ironing the thermoplastic layer with a cooled surface to form a fused crust at the backside.

29. The method of claim 28, wherein the cooled surface comprises a cooled roller.

30. A floorcovering tile comprising:
a topside that develops a topside shrinking force along the topside in response to variations in ambient conditions;
a backside opposite the topside; and
a material covering at least a portion of the backside, the material imparting a backside shrinking force along the backside in at least one direction across the backside, the backside shrinking force counter balancing the topside shrinking force.
